(19) United States
(12) Patent Application Publication
(10) Pub. No.: US 2026/0359949 A1
(43) Pub. Date: Nov. 12, 2026

(54) SYSTEM AND METHOD FOR PROCESSING AN IMAGE OF A VEHICLE

(71) Applicant: Che-An Liu, Taichung City (TW)

(72) Inventor: Che-An Liu, Taichung City (TW)

(21) Appl. No.: 19/668,555

(22) Filed: May 5, 2026

(30) Foreign Application Priority Data
May 6, 2025 (TW) 114116936

(51) Int. Cl. G06T 5/70; G06F 21/62; G06V 10/25; G06V 20/52; G06V 20/62

(52) U.S. Cl. CPC G06T 5/70; G06V 10/25; G06V 20/52; G06V 20/625; G06F 21/6254; G06T 2207/30232; G06T 2207/30248; G06V 2201/08

(57) ABSTRACT

A method for processing an image of a vehicle is provided. A computer device used to receive a captured image of a vehicle, and performs image recognition on the captured image. In response to identifying an entirety of a license plate from a license plate position of the vehicle in the captured image, the computer device defines at least one bounding region that includes a first bounding region around the license plate in the captured image, and performs a blurring operation on the captured image except for the at least one bounding region, while maintaining at least a color of the vehicle to be identifiable, thereby obtaining a processed image that is stored as an evidence image.

### CROSS-REFERENCE TO RELATED APPLICATION

This application claims priority to Taiwanese Invention Patent Application No. 114116936, filed on May 6, 2025, the entire disclosure of which is incorporated by reference herein.

### FIELD

The disclosure relates to a system and a method for processing an image, and more particularly to a system and a method for processing an image of a vehicle.

### BACKGROUND

Conventional parking fee collection systems typically deploy a parking post equipped with a camera adjacent to a parking space, or alternatively utilize an embedded camera installed in or near the parking space. The camera is used to capture an image of a vehicle parked within the parking space. The captured image is then subjected to image analysis to identify a license plate of the vehicle. Upon successful identification of the license plate, the image containing the license plate is stored as evidence for subsequent fee collection or verification purposes.

However, when capturing images, the camera may also inadvertently capture pedestrians. Such pedestrians may appear in the image either in full body or partially, for example, only the lower body. In cases where a pedestrian is wearing a short skirt, the captured image may raise concerns regarding personal privacy.

### SUMMARY

Therefore, an object of the disclosure is to provide a method for processing an image of a vehicle that is capable of protecting personal privacy.

According to the disclosure, the method includes steps of: (A) by a computer device, receiving a captured image of a vehicle, and performing image recognition on the captured image; (B) by the computer device, in response to identifying an entirety of a license plate from a license plate position of the vehicle in the captured image, defining at least one bounding region that includes a first bounding region around the license plate in the captured image; (C) by the computer device, performing a blurring operation on the captured image except for the at least one bounding region, while maintaining at least a color of the vehicle to be identifiable, thereby obtaining a processed image; and (D) by the computer device, storing the processed image as an evidence image.

Another object of the disclosure is to provide a system for processing an image of a vehicle that is capable of protecting personal privacy.

According to the disclosure, the system includes a camera device disposed to capture an image of the vehicle to obtain a captured image, and a computer device communicatively coupled to said camera device. The computer device is configured to receive the captured image and perform image recognition on the captured image. In response to identifying an entirety of a license plate from a license plate position of the vehicle in the captured image, the computer device defines at least one bounding region that includes a first bounding region around the license plate in the captured image. The computer device is configured to perform a blurring operation on the captured image except for the at least one bounding region, while maintaining at least a color of the vehicle to be identifiable, thereby obtaining a processed image, and to store the processed image as an evidence image.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective schematic view illustrating an application of a system for processing an image of a vehicle according to this disclosure.

FIG. 2 is a block diagram illustrating an embodiment of the system for processing an image of a vehicle according to this disclosure.

FIG. 3 is a schematic diagram illustrating an image captured using the embodiment of the system.

FIG. 4 is a schematic diagram illustrating an evidence image obtained by processing the image in FIG. 3 using the embodiment of the system.

FIG. 5 is a schematic diagram illustrating another image captured using the embodiment of the system.

FIG. 6 is a schematic diagram illustrating an evidence image obtained by processing the image in FIG. 5 using the embodiment of the system.

FIG. 7 is a schematic diagram illustrating yet another image captured using the embodiment of the system.

FIG. 8 is a schematic diagram illustrating an evidence image obtained by processing the image in FIG. 7 using the embodiment of the system.

FIG. 9 is an image captured using the embodiment of the system.

FIG. 10 is an evidence image obtained by processing the image in FIG. 9 using the embodiment of the system.

FIG. 11 is an overly blurred image obtained by processing the image in FIG. 9 using the embodiment of the system.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

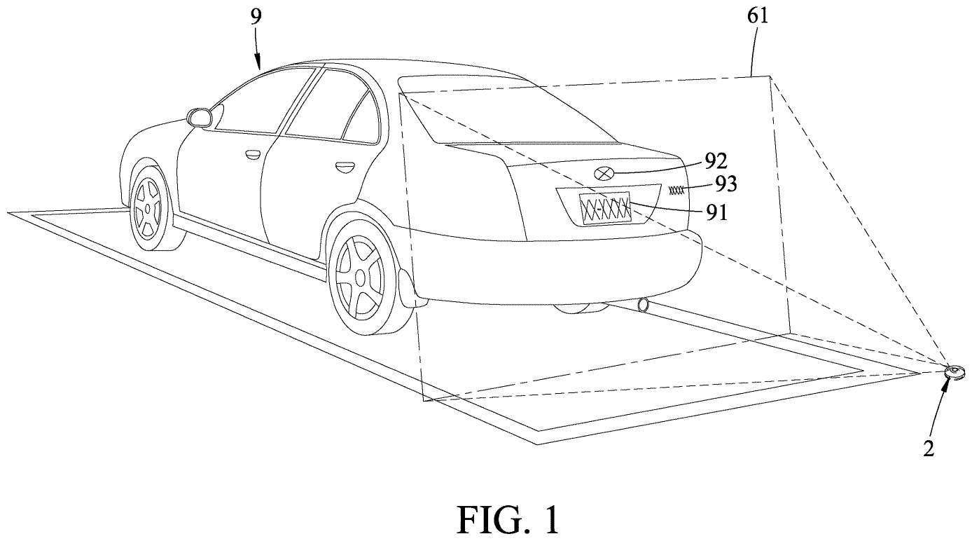

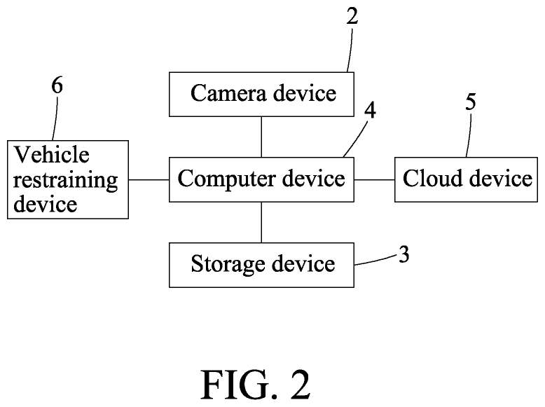

Referring to FIGS. 1 and 2, an embodiment of a system for processing an image of a vehicle includes a camera device 2, a storage device 3, a computer device 4, and optionally a cloud device 5.

The camera device 2 is disposed to face a vehicle 9 to capture an image of the vehicle 9 (referred to as a captured image 61 hereinafter). The camera device 2 is, for example, disposed in a parking facility to capture images of the vehicle 9 parked therein, or disposed on a highway to capture images of the vehicle 9 traveling thereon, and this disclosure is not limited in this respect.

The computer device 4 is communicatively coupled to the camera device 2 and the cloud device 5 with the signal being transmitted, for example, via a network. The computer device 4 receives the captured image 61 from the camera device 2, and performs image recognition on the captured image 61. When the computer device 4 identifies an entirety of a license plate 91 from a license plate position of the vehicle 9 in the captured image 61, the computer device 4 defines at least one bounding region that includes a first bounding region around the license plate 91 in the captured image 61, and performs a blurring operation on the captured image 61 except for the bounding region(s) to blur image regions outside the bounding region(s), while maintaining a color and/or a type of the vehicle 9 to be identifiable, thereby obtaining a processed image. In this embodiment, the blurring operation is exemplified as a mosaic operation, but this disclosure is not limited in this respect. The type of the vehicle herein refers to distinct body shapes, which facilitate recognition and classification. For example, the vehicle type may include a sedan, a sport utility vehicle (SUV), a van, a light truck, etc.

Referring to FIGS. 2, 3 and 4, the computer device 4 stores the processed image as an evidence image 62 in the storage device 3, the cloud device 5, or both.

In accordance with some embodiments, the computer device 4 may a remote server, for example, a server of an operating and management entity for image processing. The storage device 3 may be a built-in storage device of the remote server. The cloud device 5 may be a server of a government agency or a public server.

An embodiment of a method for processing an image of a vehicle according to this disclosure is adapted for use by the aforesaid system, and is implemented by the computer device 4. The method includes steps S1 to S5.

In step S1, the computer device 4 receives a captured image 61 related to a vehicle 9, and performs image recognition on the captured image 61.

In detail, the camera device 2 captures an image toward the vehicle 9 to obtain the captured image 61, and transmits the captured image 61 to the computer device 4 for image recognition.

The computer device 4 determines whether an entirety of a license plate 91 can be identified or recognized from a license plate position of the vehicle 9 in the captured image 61. In some embodiments, the computer device 4 may be set to further recognize a brand logo 92 and a textual marking 93 of the vehicle 9 from the captured image 61. The textual marking 93 herein refers to characters and/or slogans provided on the vehicle 9, in addition to the license plate 91 and the brand logo 92, including but not limited to a model name, a trim level, a brand slogan, or a series name of the vehicle 9.

In accordance with some embodiments, the computer device 4 may be configured to delete the captured image 61 and not perform subsequent processing in step S1 when the computer device 4 is unable to identify both the entirety of the license plate 91 and an entirely of the brand logo 92, thereby reducing computational power consumption and saving storage space.

In step S2, the computer device 4 defines a bounding region around the license plate 91 in the captured image 61 upon identifying the entirety of the license plate 91 from the license plate position of the vehicle 9 in the captured image 61.

The determination as to whether the entirety of the license plate 91 is recognized may be made, for example, based on whether a complete outer contour of the license plate 91 can be identified, or whether all characters on the license plate 91 can be recognized, but this disclosure is not limited in this respect.

In accordance with some embodiments, the computer device 4 may further define another bounding region around the brand logo 92 in the captured image 61 in step S2. In accordance with some embodiments, the computer device 4 may further define yet another bounding region around the textual marking 93 in the captured image 61 in step S2.

In step S3, the computer device 4 performs a blurring operation on the captured image 61 except for the bounding region(s) defined in step S2 (i.e., the image content in the bounding region(s) is not blurred), while maintaining at least a color of the vehicle 9 to be identifiable (e.g., preserving color information at a position corresponding to a body portion of the vehicle 9), thereby obtaining a processed image.

In accordance with some embodiments, the blurring operation includes a mosaic operation that blurs image regions outside the bounding region(s). In the illustrative embodiment, the computer device 4 maintains a type and the color of the vehicle 9 to be identifiable in the processed image by, for example, setting a mosaic block size to be smaller than a predetermined threshold.

In step S4, the computer device 4 stores the processed image obtained in step S3 as an evidence image 62. In some embodiments, the computer device 4 stores the captured image 61 and the evidence image 62 in a predetermined location.

In other words, after completion of the image processing, the computer device 4 may, according to a preset configuration, store both the captured image 61 and the evidence image 62 in the storage device 3, the cloud device 5, or both.

In some embodiments, the computer device 4 may delete the captured image 61 after the completion of the image processing. Since the unprocessed captured image 61 may include private images of pedestrians, deleting the unprocessed captured image 61 can reduce the risk of privacy leakage and further save storage space.

The evidence image 62 may be used by the operating and management entity to perform a predetermined action related to the vehicle 9 subsequently. For example, when the system is used in a parking facility, the evidence image 62 may record a capture time that serves as a parking start time, allowing the operating and management entity to charge a corresponding parking fee. In accordance with some embodiments, the parking facility may include a vehicle restraining device 6 (e.g., an exit barrier, a ground-mounted movable barrier, etc.) communicatively connected to and operable by the computer device 4, and configured to restrain movement of the vehicle 9 in the parking facility. The computer device 4 identifies vehicle information (e.g., a license plate number, a vehicle color, a vehicle type, etc.) based on the evidence image 62, and controls the vehicle restraining device 6 to remove a movement restriction imposed on the vehicle 9 upon determining that a state corresponding to the vehicle information satisfies a predetermined condition (e.g., a parking fee corresponding to the vehicle information has been paid).

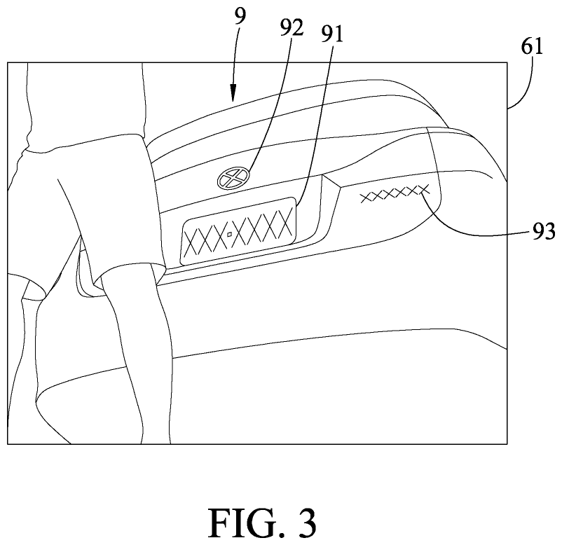

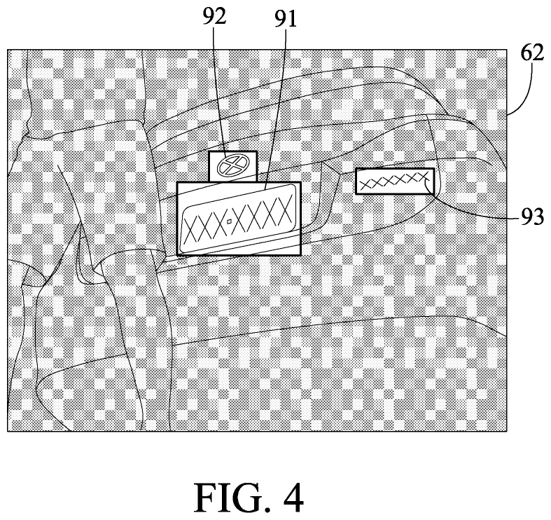

Referring to FIGS. 3 and 4, an example is shown to identify the license plate 91, the brand logo 92 and the textual marking 93 from the captured image 61. Although the captured image 61 in FIG. 3 is partially obscured by a person, the captured image 61 includes the entirety of the license plate 91, the entirety of the brand logo 92, and the entirety of the textual marking 93. Accordingly, in step S2, multiple bounding regions (represented by rectangular frames in FIG. 4) are defined to surround the license plate 91, the brand logo 92 and the textual marking 93, respectively. After performing the mosaic operation in step S3, the resulting image is as shown in FIG. 4, where all areas other than the license plate 91, the brand logo 92, and the textual marking 93 are blurred. In this manner, the risk of privacy leakage of the person can be prevented. It should be noted that the rectangular frames surrounding the license plate 91, the brand logo 92, and the textual marking 93 in FIG. 4 are provided for illustrative purposes only, and may be retained or omitted as desired in the evidence image 62.

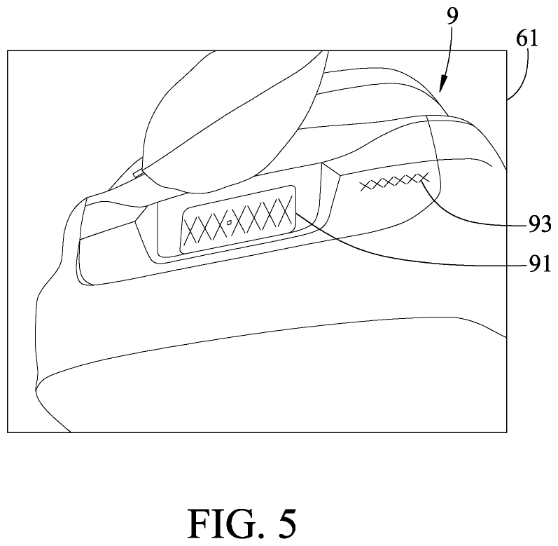

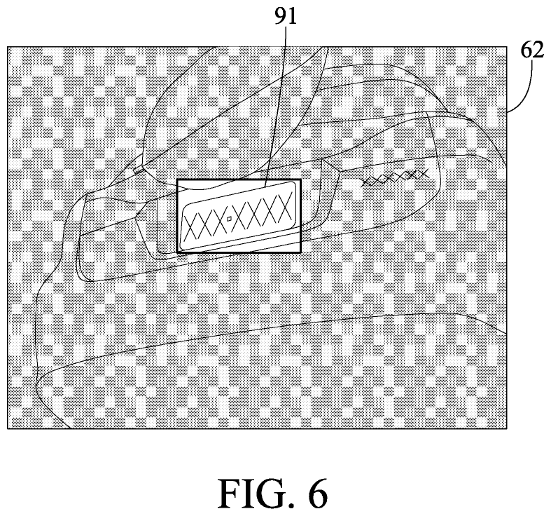

Referring to FIGS. 2, 5 and 6, another example is shown to identify only the license plate 91 from the captured image 61. In FIG. 5, although the captured image 61 is partially obstructed by leaves blocking the camera device 2, such that the brand logo 92 (see FIG. 3) cannot be recognized, the entirety of the license plate 91 is still present in FIG. 5. Accordingly, even when only the license plate 91 is recognized or identified, the captured image 61 may still be processed to obtain the evidence image 62. After the captured image 61 of FIG. 5 undergoes step S2 to frame the license plate 91 and subsequently step S3 to perform the blurring operation, the resulting processed image is as shown in FIG. 6, where all areas other than the region of the license plate 91 are blurred.

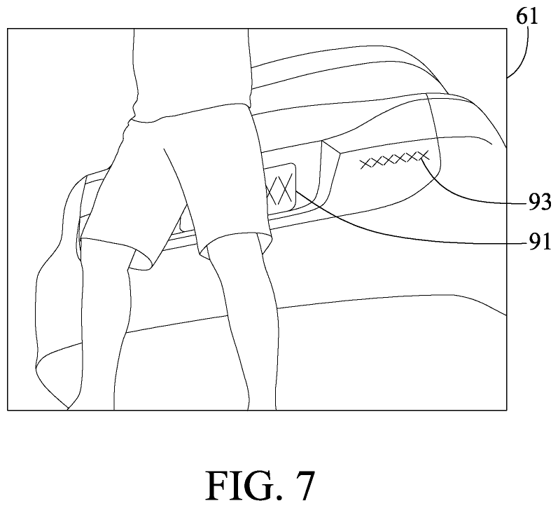

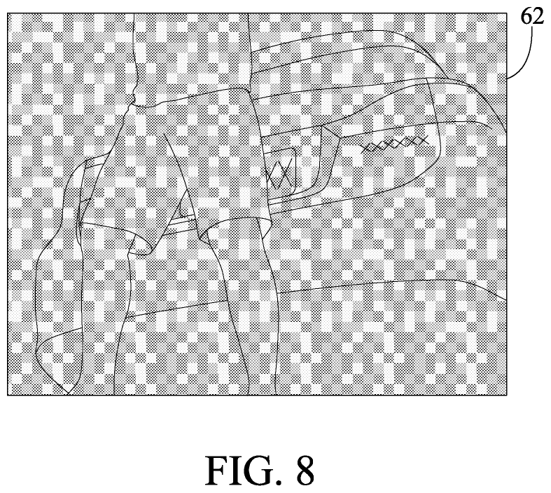

Referring to FIGS. 7 and 8, in yet another example, the system may be configured to identify only the license plate 91 and the brand logo 92. For instance, in FIG. 7, the captured image 61 is obstructed by a pedestrian such that neither the license plate 91 nor the brand logo 92 (see FIG. 3) can be completely recognized or identified. In this case, after the captured image 61 as shown in FIG. 7 undergoes step S2 and step S3, the resulting processed image is as shown in FIG. 8, in which the entire image is in a blurred state.

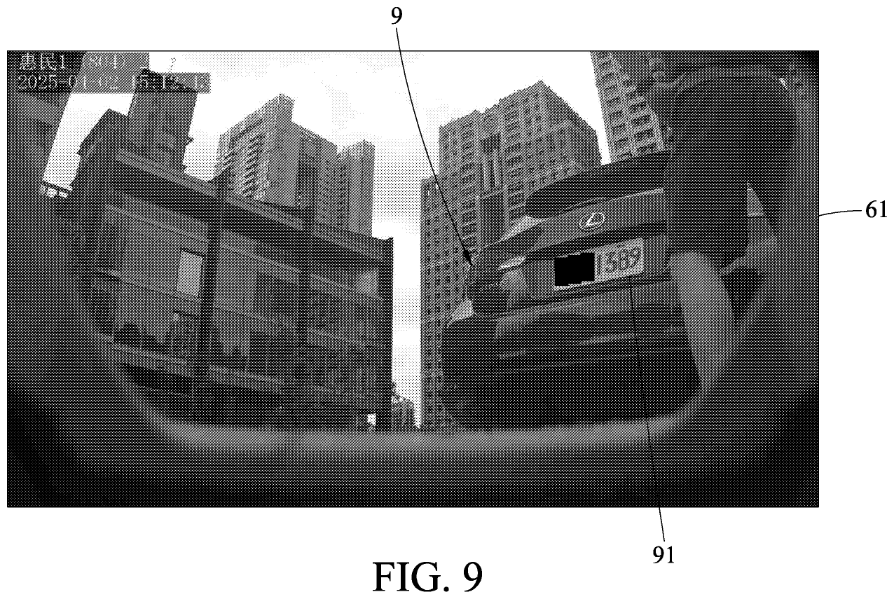

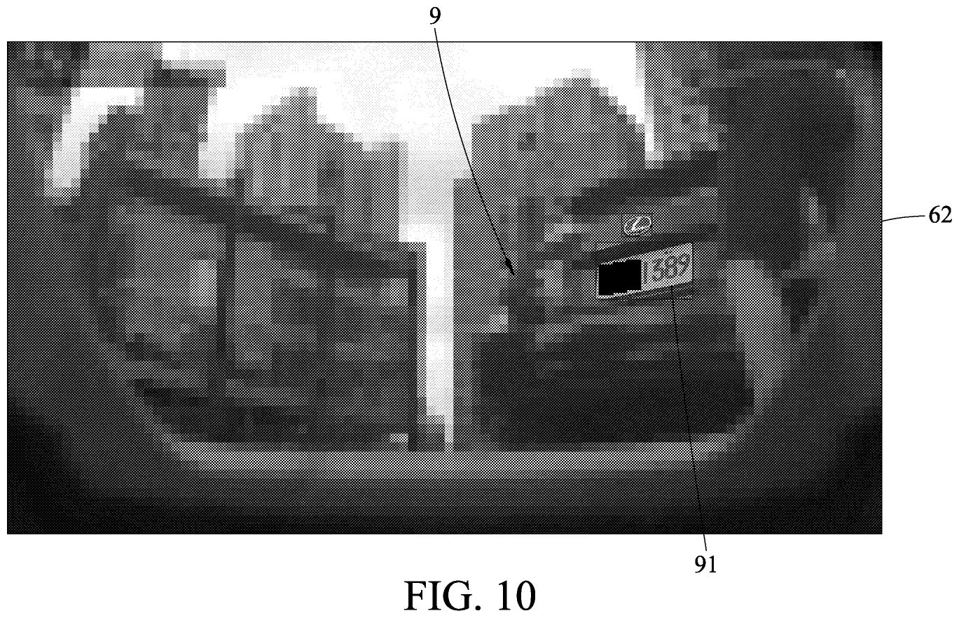

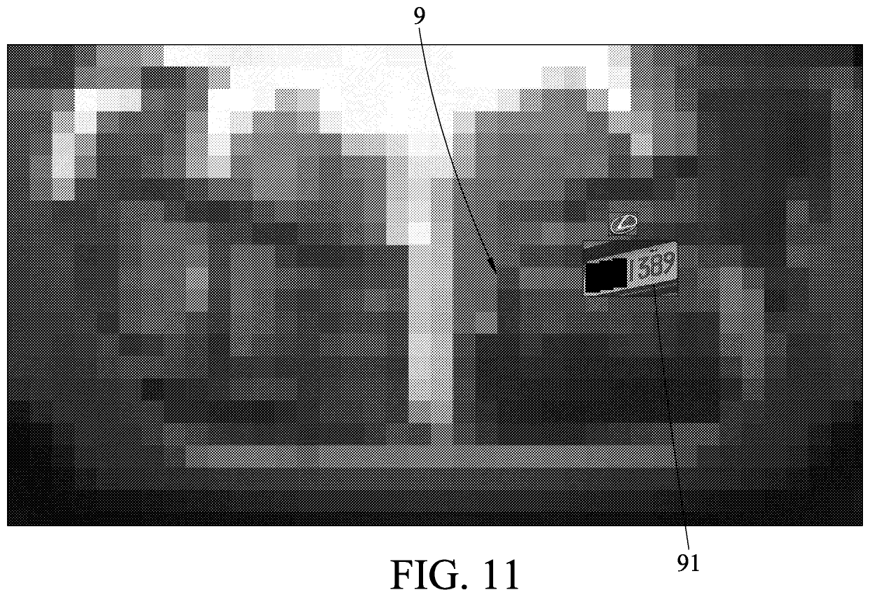

Referring to FIGS. 9 to 11, in practical applications, the mosaic block size may be adjusted according to the resolution of the captured image 61, so as to blur pedestrians'privacy while maintaining the type and the color of the vehicle 9 in an identifiable state. FIGS. 9 to 11 illustrate a captured image 61 actually photographed and processed in this embodiment, an evidence image 62, and an overly blurred image. It should be noted that, in order to avoid disclosure of personal information, in FIGS. 9 to 11, the first three letters of the license plate 91 are blacked out. In actual application, however, such blacking-out would not be performed. Furthermore, as described above, the framed boxes shown in FIGS. 10 and 11 may be retained or omitted as required, and this disclosure is not limited in this respect.

FIG. 9 shows the captured image 61 in a 1080P format (1920×1080 pixels). FIG. 10 shows the evidence image 62 obtained after the blurring operation is performed on the captured image 61 in FIG. 9 with a mosaic block size of 20×20 pixels. It can be seen from FIG. 10 that the pedestrian has been blurred, while the type and the color o f the vehicle 9 remain identifiable, so the blurring effect shown in FIG. 10 is appropriate and the resulting image is suitable for use as the evidence image 62. FIG. 11 shows an overly blurred image obtained after the blurring operation has been performed on the captured image 61 in FIG. 9 with a mosaic block size of 50×50 pixels. It can be seen from FIG. 11 that both the pedestrian and the type of the vehicle 9 have been blurred, and only the color of the vehicle 9 remains identifiable. This constitutes excessive blurring and the resulting image is therefore not suitable for use as the evidence image 62 (see FIG. 10).

In summary, referring to FIGS. 2 to 4, the computer device 4 identifies and defines at least one bounding region around the license plate 91, and then performs the blurring operation on other image regions while maintaining at least the color of the vehicle 9 in an identifiable state. Accordingly, while preserving identification information required for the evidence image 62, such as the license plate 91 and the vehicle color, unnecessary image regions may be blurred, thereby achieving the effect of protecting the privacy of pedestrians from disclosure.

In some embodiments, the computer device 4 may maintain both the type and the color of the vehicle 9 in an identifiable state after the blurring operation, so vehicle type information may also be preserved in the evidence image 62, thereby increasing the completeness of the identification information.

In some embodiments, by further identifying the brand logo 92 and the textual marking 93, the computer device 4 may provide additional identification information in the evidence image 62.

After completion of the image processing, the computer device 4 may delete the captured image 61, thereby reducing the likelihood of unauthorized dissemination of the unprocessed captured image 61, thereby lowering the risk of privacy leakage and saving storage space.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for processing an image of a vehicle, comprising steps of:
A) by a computer device, receiving a captured image of a vehicle, and performing image recognition on the captured image;
B) by the computer device, in response to identifying an entirety of a license plate from a license plate position of the vehicle in the captured image, defining at least one bounding region that includes a first bounding region around the license plate in the captured image;
C) by the computer device, performing a blurring operation on the captured image except for the at least one bounding region, while maintaining at least a color of the vehicle to be identifiable, thereby obtaining a processed image; and
D) by the computer device, storing the processed image as an evidence image.

2. The method as claimed in claim 1, wherein the blurring operation includes a mosaic operation that blurs image regions outside the at least one bounding region.

3. The method as claimed in claim 1, wherein the computer device performs the blurring operation in such a way that a type of the vehicle is maintained to be identifiable.

4. The method as claimed in claim 1, wherein, in step B), the at least one bounding region further includes a second bounding region around a brand logo of the vehicle in the captured image in response to identifying an entirety of the brand logo from the captured image.

5. The method as claimed in claim 4, further comprising a step of:
E) by the computer device, deleting the captured image in response to not identifying both the entirety of the license plate and the entirety of the brand logo from the captured image.

6. The method as claimed in claim 1, wherein, in step B), the at least one bounding region further includes a second bounding region around a textual marking in the captured image in response to identifying the textual marking from the captured image.

7. The method as claimed in claim 1, wherein step D) further includes deleting the captured image.

8. The method as claimed in claim 1, wherein, in step D), the computer device stores the captured image and the evidence image in a predetermined storage location.

9. The method as claimed in claim 1, further comprising a step of:
E) by the computer device, identifying vehicle information based on the evidence image, and controlling a vehicle restraining device to remove a movement restriction imposed on the vehicle in response to a state corresponding to the vehicle information satisfying a predetermined condition.

10. A system for processing an image of a vehicle, comprising:
a camera device disposed to capture an image of the vehicle to obtain a captured image; and
a computer device communicatively coupled to said camera device, and configured to
receive the captured image,
perform image recognition on the captured image,
in response to identifying an entirety of a license plate from a license plate position of the vehicle in the captured image, define at least one bounding region that includes a first bounding region around the license plate in the captured image,
perform a blurring operation on the captured image except for the at least one bounding region, while maintaining at least a color of the vehicle to be identifiable, thereby obtaining a processed image, and
store the processed image as an evidence image.

11. The system as claimed in claim 10, wherein the blurring operation includes a mosaic operation that blurs image regions outside the at least one bounding region.

12. The system as claimed in claim 10, wherein said computer device is configured to perform the blurring operation in such a way that a type of the vehicle is maintained to be identifiable.

13. The system as claimed in claim 10, wherein the at least one bounding region further includes a second bounding region around a brand logo of the vehicle in the captured image in response to said computer device identifying an entirety of the brand logo from the captured image.

14. The system as claimed in claim 13, wherein said computer device is further configured to delete the captured image in response to identifying neither the entirety of the license plate nor the entirety of the brand logo from the captured image.

15. The method as claimed in claim 10, wherein the at least one bounding region further includes a second bounding region around a textual marking in the captured image in response to said computer device identifying the textual marking from the captured image.

16. The system as claimed in claim 10, wherein said computer device is configured to delete the captured image after storing the processed image as the evidence image.

17. The system as claimed in claim 10, wherein said computer device is configured to store the captured image and the evidence image in a predetermined storage location.

18. The system as claimed in claim 10, wherein said computer device is configured to identify vehicle information based on the evidence image, and to control a vehicle restraining device to remove a movement restriction imposed on the vehicle in response to a state corresponding to the vehicle information satisfying a predetermined condition.
